(19) United States
(12) Patent Application Publication
(10) Pub. No.: US 2002/0067868 A1
(43) Pub. Date: Jun. 6, 2002

(54) Axial ball transfer assemblies

(76) Inventors: Gregory S. Lyon, Mamaroneck, NY (US); Alison Ng, New York, NY (US); Eric Kim, Flushing, NY (US)

Correspondence Address: David M. Carter, Esq., DILWORTH & BARRESE, LLP, 333 Earle Ovington Blvd., Uniondale, NY, 11553, US

(21) Appl. No.: 09/916,945

(22) Filed: Jul. 27, 2001

Related U.S. Application Data
(63) Continuation of application No. PCT/US00/02182, filed on Jan. 28, 2001.
(60) Provisional application No. 60/117,701, filed on Jan. 29, 1999.

(51) Int. Cl. F16C 29/06

(52) U.S. Cl. 384/43; 384/45

(57) ABSTRACT

A bearing assembly is disclosed that 410 includes at least one ball track having a load bearing portion, a return portion and a turnaround portion interconnecting the load bearing and return portions. A plurality of bearing balls are disposed in the ball tracks. At least a portion of the ball tracks are configured for unguided recirculation of the bearing balls. The bearing assembly may include a pair of ball tracks separated by a center rib. In an alternate embodiment, the bearing assembly includes at least one island disposed in at least a portion of the ball tracks. The islands facilitate recirculation of the bearing balls in the ball tracks. In another alternate embodiment, a bearing assembly is provided that includes a rail. A bearing carriage is configured to move along the rail. At least one ball track is disposed adjacent the rail and the bearing carriage. The ball tracks include a load bearing portion, a return portion and a turnaround portion interconnecting the load bearing and return portions. A plurality of bearing balls are disposed in the ball tracks. The ball tracks are configured for unguided recirculation of the bearing balls. The bearing assembly may include at least one insert having at least a portion of the ball tracks formed therein.

### BACKGROUND

1. Field of the Invention

This invention relates to bearing assemblies, and more particularly to ball track bearing assemblies that reduce friction associated with movement of two bodies relative to each other.

2. Description of the Related Art

Bearing assemblies may be of the type which support a carriage or block for movement along a support member such as an elongated shaft, rail or spline to reduce friction associated with longitudinal or rotational motion. These bearing assemblies can be of the open or closed type.

Bearing assemblies also contemplated by the present invention generally include an outer housing and a block dimensioned for insertion into the outer housing. The block defines a plurality of longitudinal planar faces each having at least one ball track in a loop configuration for containing and recirculating bearing balls. The ball tracks include open portions which facilitate load transfer from the supporting shaft to load bearing structure such as ball retainers operatively associated with either the block or the outer housing. Return portions of the ball tracks permit continuous recirculation of the bearing balls through the ball tracks during linear motion. The block is typically formed as a monolithic element with the ball tracks integrally incorporated therein. See, U.S. Pat. No. 3,767,276 to Henn. This structure, however, is difficult to efficiently manufacture because of the complex molds required. In particular, the ball tracks are incorporated into the molds and the ball tracks may require further machining operations for precise alignment and tolerances of the ball tracks for proper recirculation of the bearing balls.

Linear motion recirculating bearing assemblies having multiple tracks for longitudinal movement along a shaft are known in the art. See, for example, U.S. Pat. Nos. 4,181,375, 4,293,166, 4,463,992 and U.S. Pat. No. 3,545,826 entitled Compliant and Self-Aligning Ball Bearing for Linear Motion. These bearing assemblies are typically characterized by a housing which forms a plurality of tracks arranged in radial planes with respect to the longitudinal axis of the shaft. Each of the tracks has a load-bearing path wherein the roller elements contact the shaft and a radially spaced return path for serially recirculating the roller elements back to the load-bearing path. Turnarounds are positioned at each axial end of the tracks to interconnect the load-bearing and return paths. These bearing assemblies, particularly the assembly shown in the '992 patent, are even more difficult to manufacture because a plurality of ball tracks are being formed.

A plurality of individual axial guides are commonly provided in conjunction with the load bearing paths to guide and separate the rolling elements in the load bearing paths. These axial guides are usually in the form of separate axially extending elements which are individually placed between the end caps at the axial ends of the bearing assembly. Similarly, a plurality of individual inner guides may be positioned at each of the inner axes of the turnarounds to guide the roller elements from the load-bearing tracks to the return tracks. Both the axial guides and the inner guides usually must be individually and separately positioned within the bearing assembly. This technique is both time consuming and inefficient.

In addition to the problems associated with assembling and positioning the axial and inner guides, bearing assemblies making use of typical individual bearing plates tend to have alignment and positioning problems associated therewith. These bearing plates are usually positioned longitudinally over the load bearing tracks and serve to transmit loads from the carriage, through the roller elements, to the shaft. If these bearing plates are not properly and securely positioned, the bearing assembly will not operate efficiently and may cause binding and/or misalignment of the rolling elements.

These designs for such linear bearing assemblies have some inherent drawbacks. For example, in the bearing of U.S. Pat. No. 4,717,264, the raceway rail has a load bearing surface and a single return surface, both formed in a lower side of the raceway rail. This arrangement does not make efficient usage of the space surrounding the rail and inhibits the placement of an optimum number of load bearing paths for a given surface area. Also, the ball turnaround structure creates a tight arc for reversal which limits the speed capacity and can result in jamming of the balls.

These bearing assemblies may be used, for example, with rack and pinion steering devices in automobiles. The steering assembly is normally of the rack and pinion type, running transverse to the axis of the vehicle. The pinion is typically loaded into the rack, such that there is a force transmitted between the rack shaft and the bottom of the housing. In rack and pinion steering gears, a rack bar transverses along its axis when the pinion, which has teeth meshing with the teeth of the rack bar, is turned by the steering wheel and column assembly. Commonly, a support yoke biases the rack bar, toward the pinion to maintain the desired meshing of the rack teeth with the pinion teeth during rotation of the pinion. The support yoke also reacts against shock loads transmitted to the rack bar from bumps in the road via the vehicle wheels, suspension and steering system tie rods.

In the past, attempts have been made to reduce the friction that results in this reaction, usually through the application of low-friction materials utilized in a known fashion. Friction can be reduced by applying low friction surface coatings to the constituent parts. Minimization of friction is an important factor for achieving a good steering feel facilitating safe driving conditions. In particular, in the case of a power failure, reducing friction allows a driver to steer a vehicle without loss of control of the vehicle. Bearing assemblies utilizing bearing balls have a particularly advantageous application with steering devices because they provide a smooth travel of the parts relative to one another. Undesirably, however, the above mentioned assemblies often incur a higher cost of manufacture and assembly due to the complex molds and precise machining operations required to form ball tracks that separate and guide the rolling elements.

Therefore, it is highly desirable to have a bearing assembly having a ball track configured to reduce friction associated with movement of two bodies relative to each other in a low cost application of rolling element technology.

Accordingly, it is one object of the present invention to provide a bearing assembly having a ball track that facilitates unguided recirculation of bearing balls for reducing friction associated with the movement of two bodies relative to each other.

It is a further object of the present invention to provide a bearing assembly including ball tracks having an efficient arrangement of load bearing and return paths to optimize quantities of bearing balls in the ball tracks.

It is another object of the present invention to provide a bearing assembly which is easily and efficiently manufactured and assembled.

These and other highly desirable objects are accomplished by the present invention in a bearing assembly having ball tracks that facilitate unguided recirculation of bearing balls disposed therein for reducing friction associated with movement of two bodies relative to each other in a low cost application of rolling element technology.

Objects and advantages of the invention are set forth in part herein and in part will be obvious therefrom or may be learned by practice with the invention, which is realized and attained by means of instrumentalities and combinations pointed out in the appended claims. The invention comprises the novel parts, construction, arrangements, combinations, steps and improvements herein shown and described.

### SUMMARY OF THE INVENTION

In accordance with the present invention, a bearing assembly is disclosed that includes at least one ball track having a load bearing portion, a return portion and a turnaround portion interconnecting the load bearing and return portions. A plurality of bearing balls are disposed in the ball tracks. At least one of either the load bearing or return portions is configured for unguided recirculation of the bearing balls.

The load bearing portion may be configured for unguided recirculation of the bearing balls. The return portion may be configured for unguided recirculation of the bearing balls. The turnaround portion may be configured for unguided recirculation of the bearing balls.

The bearing assembly may include a pair of ball tracks separated by a center rib.

In an alternate embodiment, the bearing assembly includes at least one island disposed in at least a portion of the ball tracks. The islands facilitate recirculation of the bearing balls in the ball tracks. The islands can have a substantially parabolic cross-section.

In another embodiment, the bearing assembly includes load bearing and return portions that define substantially parallel axially defined pathways for the bearing balls. The return portion may include a divider. The return portion may be laterally oriented relative to the load bearing portion.

In another alternate embodiment, in accordance with the present disclosure, a bearing assembly is disclosed that includes a block having at least a portion of a pair of ball tracks formed therein. The ball tracks are in communication and include a load bearing portion, a return portion and turnarounds interconnecting the load bearing and return portions. A plurality of bearing balls are disposed in the ball tracks. At least one of either the load bearing or return portions is configured for unguided recirculation of the bearing balls. The ball tracks may be substantially elliptical and the load bearing portions are in communication.

In yet another alternate embodiment, a bearing assembly is provided that includes a rail. A bearing carriage is configured to move along the rail. At least one ball track is disposed adjacent the rail and the bearing carriage. The ball tracks include a load bearing portion, a return portion and a turnaround portion interconnecting the load bearing and return portions. A plurality of bearing balls are disposed in the ball tracks. At least one of either the load bearing or return portions is configured for unguided recirculation of the bearing balls.

The bearing balls may be disposed in the load bearing portion and positioned to engage the rail. The bearing balls may alternatively be disposed in the load bearing portion and positioned to engage the bearing carriage. At least a portion of the ball tracks may be formed in the rail. At least a portion of the ball tracks may also be formed in the bearing carriage.

The bearing assembly may include at least one insert being positionable on an inner surface of the bearing carriage. The inserts have at least a portion of the ball tracks formed therein. The inserts may include parallel grooves defining the load bearing portion and the return portion. The parallel grooves are configured for unguided recirculation of the bearing balls.

### BRIEF DESCRIPTION OF DRAWINGS

The accompanying drawings, referred to herein and constituting a part hereof, illustrate the various embodiments of the bearing assembly of the present invention and, together with the description, serve to explain the principles of the invention.

FIG. 1 is a perspective view of a bearing assembly in accordance with one embodiment of the present invention;

FIG. 2 is a perspective view of a bearing assembly employing multiple blocks of the embodiment shown in FIG. 1;

FIG. 3 is a perspective view of an alternate embodiment of the bearing assembly shown in FIG. 1;

FIG. 4 is a cross-sectional view of the bearing assembly shown in FIG. 1;

FIG. 5 is a cross-sectional view of an alternate embodiment of the bearing assembly shown in FIG. 4;

FIG. 6 is a schematic illustration of the bearing ball path of the bearing assembly shown in FIG. 1;

FIG. 7 is a top view of an alternate embodiment of ball tracks of the bearing assembly shown in FIG. 1;

FIG. 8 is a perspective view of a ball retainer;

FIG. 9 is a perspective view of the ball retainer shown in FIG. 8 and the bearing assembly shown in FIG. 1;

FIG. 10 is a side view in part cross-section of an alternate embodiment of a bearing assembly in accordance with the present invention;

FIG. 11 is a perspective view of the bearing assembly shown in FIG. 10;

FIG. 12 is a perspective view of an alternate embodiment of ball tracks of the bearing assembly shown in FIG. 10;

FIG. 13 is a cross-sectional view, in part elevation of a bearing assembly and the ball tracks shown in FIG. 12;

FIG. 14 is a side view of an island shown in FIG. 12;

FIG. 15 is a side cross-sectional view of an alternate embodiment of the island shown in FIG. 14;

FIG. 16 is a side cross-sectional view of an another alternate embodiment of the island shown in FIG. 14;

FIG. 17 is a perspective view of an alternate embodiment of a bearing assembly in accordance with the present invention;

FIG. 18 is a cut-away perspective view of the indicated area of detail of FIG. 17;

FIG. 19 is a side cross-sectional view in part elevation of an alternate embodiment of the bearing assembly shown in FIG. 17;

FIG. 20 is a perspective view of an alternate embodiment of a track insert and bearing balls shown in FIG. 17; and

FIG. 21 is a perspective view of another alternate embodiment of the track insert and bearing balls shown in FIG. 17.

### DETAILED DESCRIPTION OF EXEMPLARY EMBODIMENTS

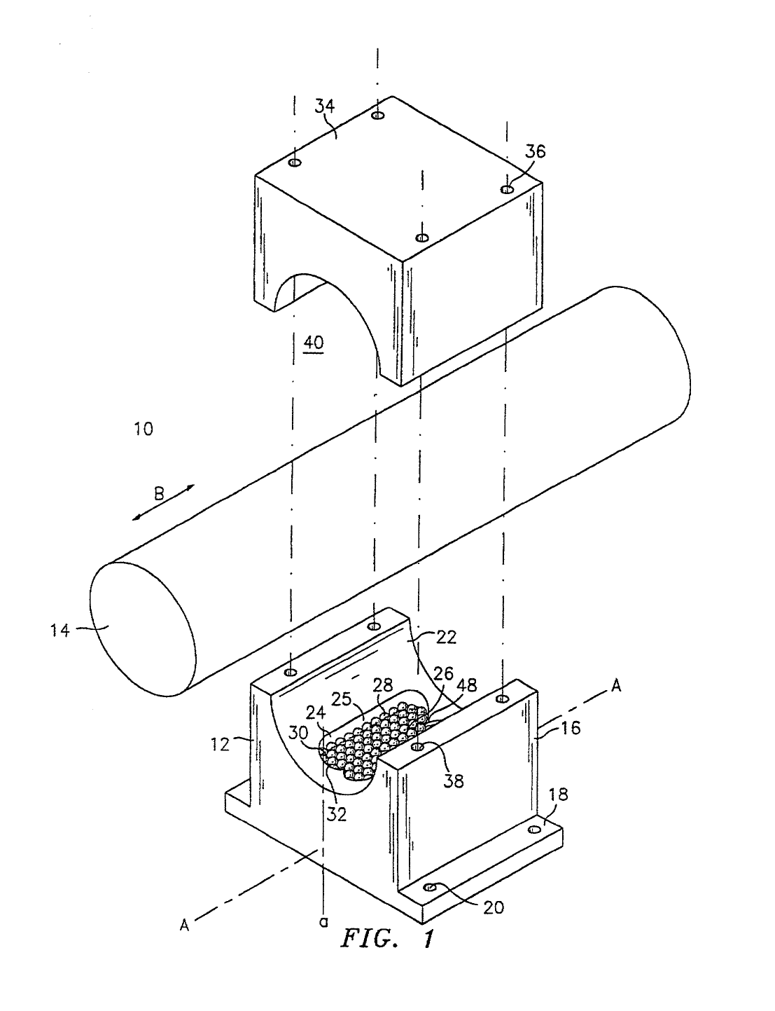

Referring now to the drawings, wherein like reference numerals identify similar structural elements of the subject invention, there is illustrated in FIG. 1 an axial ball transfer assembly, such as, for example, a bearing assembly 10 having a block 12 for use in open and closed type bearing assemblies and constructed in accordance with one embodiment of the present invention.

Bearing assembly 10 may have a portion constructed as a carriage, pillow block, outer housing, etc., for longitudinal movement or rotational movement along a support member such as, for example, an elongated shaft, rail, spline, etc. In the automotive technologies, bearing assembly 10 may be utilized in rack and pinion type apparatus for reducing frictional forces in particular situations, such as, for example, power failures, etc. Bearing assembly 10 supports a shaft 14 which may be in communication with and/or form a portion of a power steering assist mechanism (not shown) and/or a steering column (not shown).

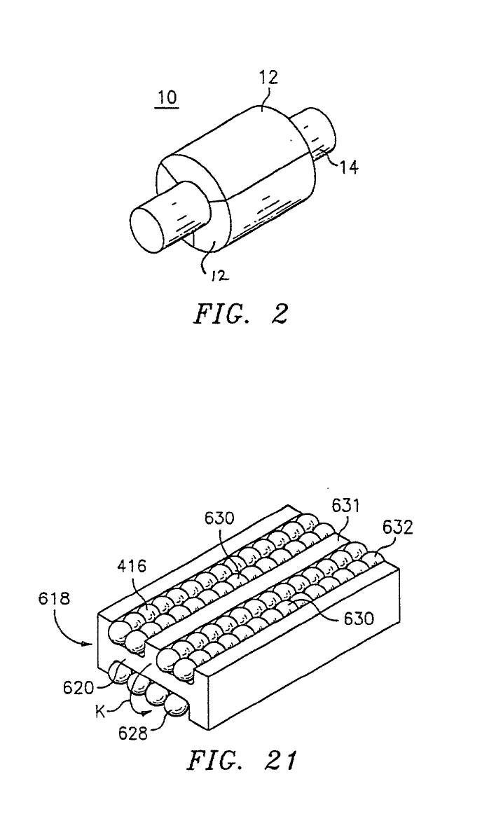

Bearing assembly 10 employs unguided recirculation of rolling elements to reduce frictional forces created with regard to two bodies moving relative to the other. The bearing assembly provides a smooth travel of moving parts associated with rolling element technology at low cost due to its simplified construction and assembly. Bearing assembly 10 may utilize a single block 12 or multiple blocks positionable adjacent one another. Block 12 can have alternate configurations and dimensions so that multiple blocks may be positioned about shaft 14, as illustrated in FIG. 2, showing a three block configuration. The orientation and number of blocks used can be dependent upon various factors relating to shaft 14, such as, for example, width, length, longitudinal or rotational motion, gravitational force, etc.

Block 12 includes a block portion 16 and a flange portion 18. Block 12 may be monolithically formed from relatively light weight and flexible machine grade material, such as, for example, aluminum, plastic or steel, depending on the bearing assembly and the associated manufacturing cost constraints of a particular bearing application. Block 12 does not require additional components and, therefore, its design provides a low cost method of manufacture. It is contemplated, however, that portions of block 12, as will be discussed, may be separately manufactured and subsequently integrally assembled with the bearing assembly.

Block 12 may be die cast from suitable metals or molded from suitable engineering plastics, for example, polyacetyls, polycarbonates, polyamides, etc. It is contemplated that engineering plastics used may incorporate metal stiffeners in order to provide sufficient rigidity for a particular bearing application. Block 12 can be formed by cold drawing processes and subsequently cut to a desired length, or extruded using known production techniques. Block 12 may be anodized, galvanized, etc., to provide corrosion resistance. One skilled in the art, however, will realize that other materials and fabrication methods suitable for assembly and manufacture, in accordance with the present invention, also would be appropriate.

Mounting holes 20 are formed in flange portion 18 of block 12 and facilitate engagement of block 12 to desired machinery components. Block portion 16 is substantially rectangular but may, however, have alternative geometric configurations such as, for example, circular, oval, etc. Block 12 may also be mounted to desired machinery components by adhesives, clips, etc.

Block 12 includes an inner surface 22 defining ball tracks 24. A pair of ball tracks 24 are formed in inner surface 22 and are substantially oval in configuration. Ball tracks 24 include a load bearing portion, such as, for example, load bearing track 26, a return portion, such as, for example, return track 28 and turnarounds 30. Turnarounds 30 interconnect load bearing track 26 and return track 28 facilitating recirculation of rolling elements.

A plurality of bearing balls 32 are disposed in ball tracks 24 for recirculation therein. Load bearing track 26 is positionable adjacent a dead-center line a of block 12. The oval configuration of ball track 24 advantageously facilitates recirculation of bearing balls 32 as a load engages those bearing balls 32 disposed in load bearing track 26 and motion of the load causes recirculation of bearing balls 32. It is contemplated that ball tracks 24 may have alternative configurations such as circular, etc.

Referring to FIG. 4, return track 28 includes a clearance b so that ball tracks 24 have a greater depth within inner surface 22 at return track 28. It is contemplated that clearance b can be dependent on the configuration and/or dimension of shaft 14. This configuration facilitates engagement of shaft 14 at load bearing track 26 adjacent dead-center line a, and not at return track 28. Alternatively, the load bearing and return portions may be interchangeably positioned.

Referring to FIG. 5, block 12 includes ball tracks 124 having a load bearing track 126 positionable adjacent an end 127 of block 12. A return track 128 is positionable adjacent dead-center line a. Ball tracks 124 have a greater depth within inner surface 22 at return track 128 so that shaft 14 is caused to engage load bearing track 126, adjacent end 127 of block 12 and not at return track 128, adjacent dead-center line a.

As shown in FIG. 1, the pair of ball tracks 24 include dividers 48 that facilitate unguided recirculation of bearing balls 32. Ball tracks 24 do not define separate tracks or axial guides. This configuration of ball tracks 24 allows block 12 to be molded from an engineering plastic whereby the molds are not complex and the design facilitates ease of manufacture and assembly. Further, secondary machining operations to precisely machine ball tracks or axial guides are not required.

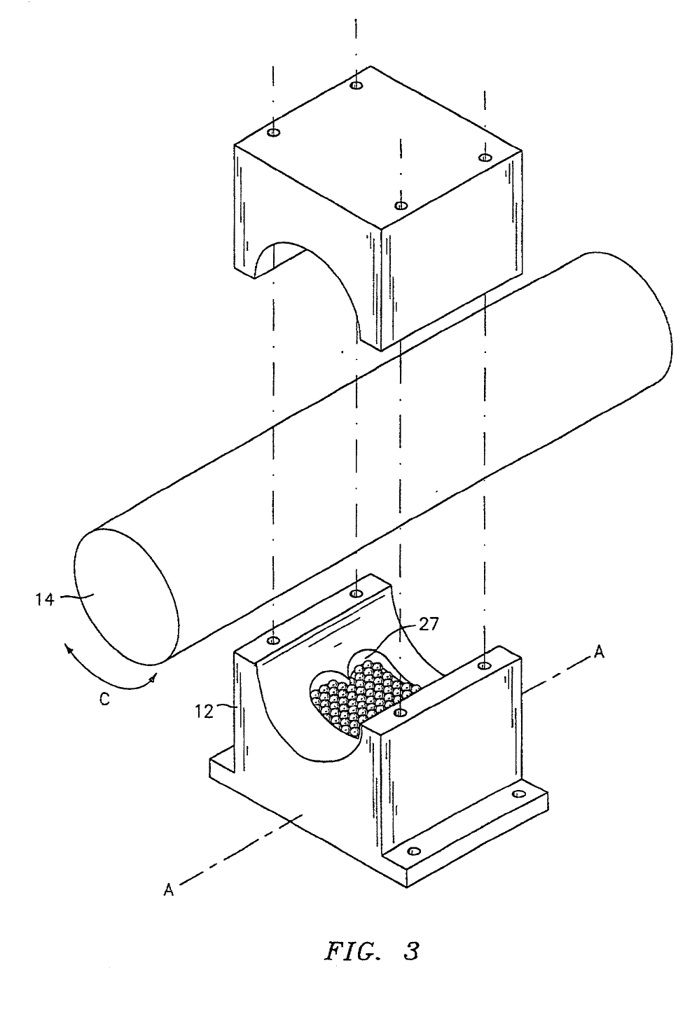

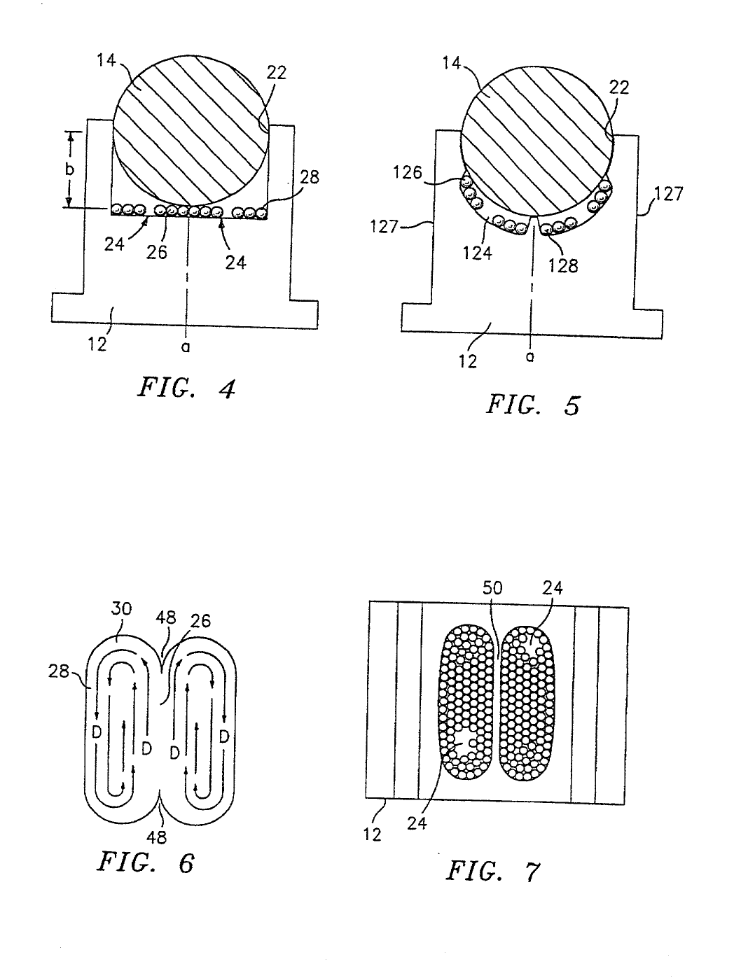

Alternatively, as shown in FIG. 7, block 12 has a center rib 50 included between the pair of ball tracks 24 to separate the ball tracks. This configuration prevents crossover of bearing balls 32 into opposing ball tracks 24 and prevents lockup. Each ball track 24 functions separately with regard to load transfer from shaft 14. The pair of ball tracks 24 are advantageously included to create a straddled condition along shaft 14. Bearing balls 32 are typically loaded at bottom dead center of block 12.

Ball tracks 24 are configured for unguided recirculation of bearing balls 32. An inner surface 25 of ball track 24 is not modified or machined to guide or separate recirculation of bearing balls 32. The configuration of ball tracks 24 allows for an optimization of ball track quantities disposed therein. Also, by providing for increased ball track quantities, the bearing assembly has improved load characteristics and a longer useful life. Inner surface 22 of block 12 has a radial configuration for receipt and support of shaft 14 facilitating longitudinal and/or rotational motion of shaft 14 through engagement with bearing balls 32.

Ball tracks 24 are axially elongated relative to their width, along an axis A, to reduce friction and facilitate axial motion to compensate for longitudinal movement of shaft 14, shown by arrow B. Alternatively, as illustrated in FIG. 3, block 12 includes ball tracks 27 that are elongated in a substantially perpendicular orientation to axis A to compensate for rotational movement of shaft 14, as shown by arrow C. Ball tracks 24 (FIG. 1) and 27 (FIG. 3) are configured such that only the load bearing portions engage shaft 14, as will be discussed below.

Bearing assembly 10 includes a block cap portion 34 to facilitate support of shaft 14 within block 12. Mounting thru-holes 36 cooperate with mounting holes 38 of block 12 to maintain shaft 14 within block 12. Bolts, screws, etc., may be used to facilitate alignment of the mounting holes. It is contemplated that adhesives, pins, etc., may be used to maintain cap portion 34 engaged with block 12. It is also contemplated that cap portion 34 may be hingedly attached to the body of block 12. Cap portion 34 has an inner surface 40 fabricated from a low friction material that facilitates movement of shaft 14 relative thereto. It is contemplated, however, that inner surface 40 may not engage shaft 14.

Alternatively, as shown in FIGS. 8 and 9, block 12 includes a ball retainer 54. Ball retainer 54 is dimensioned and configured to engage inner surface 22 of block 12 in a flush engagement. Ball retainer 54 defines a longitudinal opening 56 that allows bearing balls 32 to contact shaft 14 at load bearing track 26 for recirculation of bearing balls 32 in ball track 24. Ball retainer 54 covers return track 28 and prevents undesired engagement of bearing balls 32 with shaft 14. Ball retainer 54 also advantageously prevents accumulation of contaminants within ball track 24 that may adversely affect operation of bearing assembly 10.

Bearing assembly 10, in accordance with the embodiments discussed with regard to FIGS. 1-9, is easily and efficiently assembled employing the disclosed components of the present invention. Bearing balls 32 are loaded into ball tracks 24 (or ball tracks 27 in FIG. 3) for recirculation therein. Shaft 14 is disposed within block 12 and supported therein by cap portion 34, discussed above.

Shaft 14 includes longitudinal motion, as shown by arrow B (or rotational motion, as shown by arrow C in FIG. 3). Shaft 14 engages bearing balls 32 at load bearing track 26 of ball tracks 24. Shaft 14 does not engage those bearing balls within return track 28 due to the configuration of ball tracks 24, discussed with regard to FIG. 4.

Referring to FIG. 6, as shaft 14 moves (longitudinally, as shown by arrow B in FIG. 1, and/or rotationally as shown by arrow C in FIG. 3), shaft 14 engages bearing balls 32 disposed within load bearing track 26. Due to the engagement with shaft 14 and its corresponding motion, bearing balls 32 are caused to recirculate within ball tracks 24, as shown by arrows D and discussed above.

Shaft 14 engages bearing balls 32 at load bearing track 26 causing bearing balls 32 to recirculate within ball track 24 in an unguided configuration through turnarounds 30, return track 28, and back to load bearing track 26 for engagement with shaft 14.

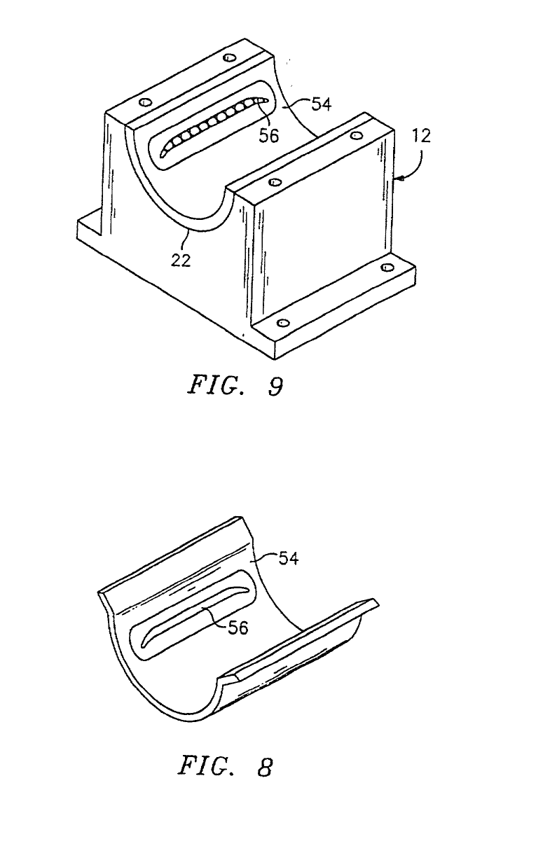

Referring to FIGS. 10 and 11, an alternate embodiment of bearing assembly 10 is shown. Bearing assembly 10 includes a block 212 having bearing balls 232 disposed therein. Block 212 is configured for unguided recirculation of rolling elements to reduce the frictional forces created with regard to two bodies moving relative to each other. Bearing assembly 10 may include single or multiple blocks 212, similar to that described above. Block 212 can be mounted to desired machinery components.

Block 212 defines ball tracks 224. Ball tracks 224 include a load bearing track 226, a return track 228 and turnarounds 230. Turnarounds 230 interconnect load bearing track 226 and return track 228 facilitating recirculation of bearing balls 232. Load bearing track 226 and return track 228 are axially aligned and spaced apart in a parallel orientation relative to longitudinal axis A. Block 212 reduces friction corresponding to motion of shaft 14.

Ball tracks 224 are configured for unguided recirculation of bearing balls 232, similar to that described with regard to FIGS. 1-6. An inner surface 225 of ball track 224 is not modified or machined to guide or separate recirculation of bearing balls 232. The configuration of ball tracks 224 allows for an optimization of ball track quantities.

An inner surface 222 of block 212 has a radial configuration for receipt and support of shaft 14 facilitating longitudinal motion of shaft 14 and reduction of friction through engagement with bearing balls 232. Load bearing track 226 of ball tracks 224 is oriented for axial motion of bearing balls 232 upon engagement with shaft 14 to compensate for frictional forces produced during longitudinal motion of shaft 14, shown by arrow E.

Alternatively, block 212 may include ball tracks 224 oriented for motion substantially perpendicular to axis A to compensate for rotational motion of shaft 14, as shown by arrow G in FIG. 11.

Bearing assembly 10, in accordance with the embodiments discussed with regard to FIGS. 10 and 11, is easily and efficiently assembled employing the disclosed components of the present invention. Bearing balls 232 are loaded into block 212 and block 212 is assembled with shaft 14. Shaft 14 includes longitudinal motion, shown by arrow E, and engages bearing balls 232 at load bearing track 226 of ball tracks 224. Bearing balls 232 recirculate within ball track 224, as shown by arrow F, in an unguided configuration from load bearing track 226, turnarounds 230, to return track 228 and back to load bearing portion 226 for engagement with shaft 14, corresponding to motion of shaft 14.

Referring to FIGS. 12 and 13, an alternate embodiment of block 212 is shown. Block 212 includes ball tracks 324 having islands 352 to facilitate unguided recirculation, discussed above, of bearing balls 232. Islands 352 have a foil like configuration facilitating a smooth flow of bearing balls 232 within ball tracks 324. Islands 352 also advantageously prevent jamming or clogging of the bearing ball flow. Islands 352 are axially elongated along axis A and include a span c.

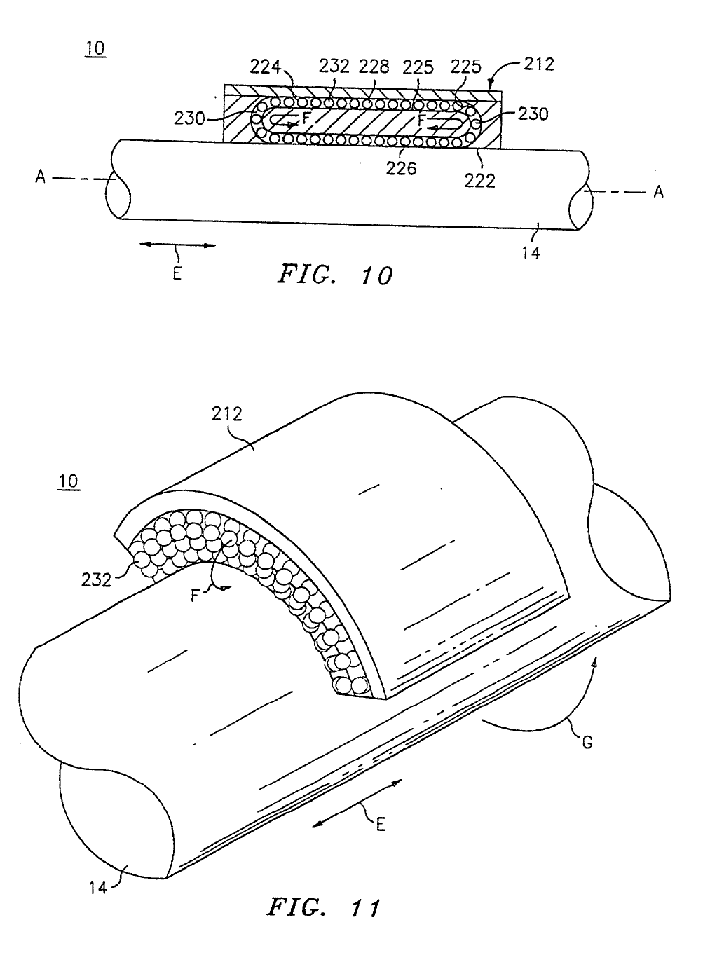

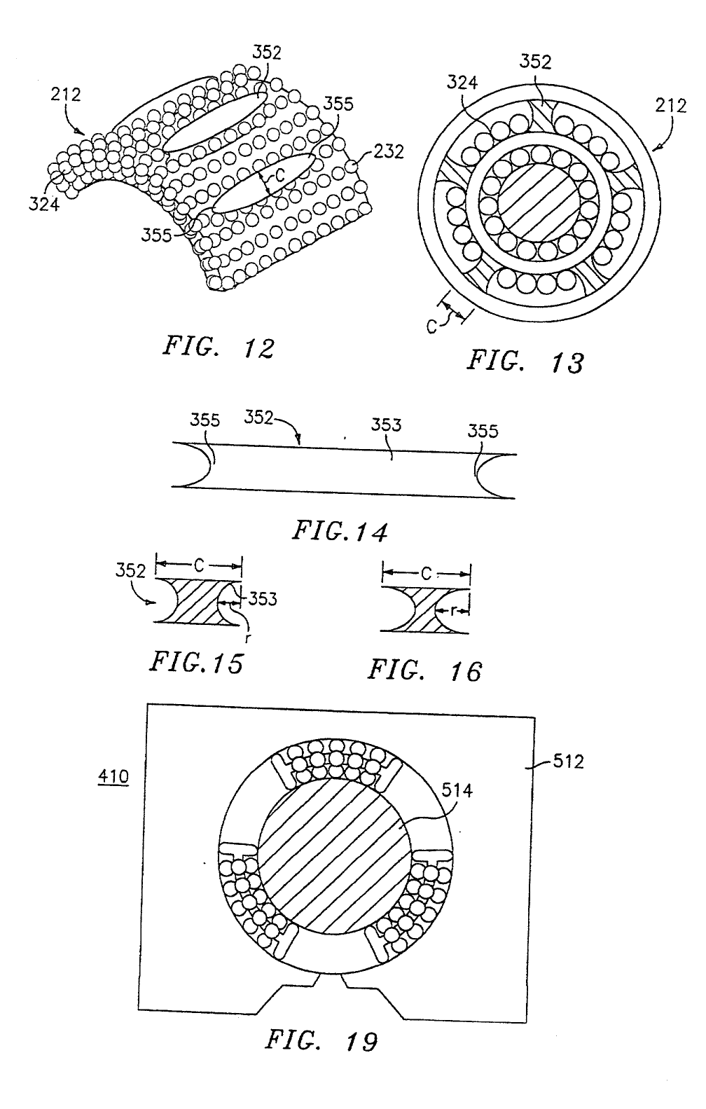

Referring to FIG. 14, islands 352 may include a parabolic configuration along an inner surface 353 thereof facilitating flow of bearing balls 232 without stagnation or lockup. Referring to FIG. 15, islands 352 include a parabolic configuration having a smaller radius r to facilitate bearing balls 232 flow away from inner surface 353. Referring to FIG. 16, islands 352 include a parabolic configuration having a larger radius r increasing the tendency of bearing balls 232 to flow near a leading edge 355, shown in FIGS. 12 and 14.

Referring to FIG. 17, an alternate embodiment of the bearing assembly, in accordance with the present disclosure is shown. A partially assembled bearing assembly 410 includes an inverted substantially U-shaped bearing carriage 412 configured and dimensioned to move along a rail assembly 414 on rolling elements 416. Bearing assembly 410 includes track inserts 418 spaced about the bearing assembly for receiving a load and reducing friction. Track inserts 418 include a ball track 420 disposed adjacent rail assembly 414 and bearing carriage 412. As will be discussed in detail below, a plurality of bearing balls 416 are disposed in ball tracks 420.

Ball tracks 420 are configured for unguided recirculation of bearing balls 416, similar to that described above, during motion of rail assembly 414 relative to bearing carriage 412. Although shown here as balls, other rolling elements are also contemplated, including rollers. It is contemplated that inserts 418 may include a single or multiple ball tracks. It is further contemplated that bearing assembly 410 may include a single or multiple inserts 418.

Bearing carriage 412 has a bearing carriage portion 422 and a pair of depending legs 424 extending therefrom. Bearing carriage 412 is formed from relatively lightweight and flexible machine grade material such as, for example, aluminum, plastic or steel. It is envisioned that bearing carriage 412 may be roll formed from sheet material. Bearing carriage 412 may be coated for corrosion resistance, such as, for example, by anodizing, galvanizing, etc. Mounting holes 426 are formed in the upper planar surface of carriage portion 422 of bearing carriage 412 and facilitate engagement to desired machinery components. Bearing carriage 412 may include longitudinal reliefs formed therein for additional flexure.

Referring to FIG. 18, ball tracks 420 include a load bearing track 428, a return track 430 and turnarounds 432 interconnecting load bearing track 428 and return track 430. Turnarounds 432 are positioned on each longitudinal end of track inserts 418. Ball tracks 420 are configured for unguided recirculation of bearing balls 416, similar to that described above. An inner surface 421 of ball tracks 420 is not modified or machined to guide or separate recirculation of bearing balls 416. This configuration allows for optimization of ball track quantities.

Turnarounds 432 may include, for example, end caps 434 or portions thereof positioned on each longitudinal end of bearing carriage 412 (only one end cap 434 is shown in FIG. 17). End caps 434 serve to enclose and connect corresponding load bearing and return tracks, 428 and 430 of respective inserts 418. It is contemplated that end caps 434 may employ semi-toroidal turnarounds and the like (see, e.g., Lyon, U.S. Pat. No. 5,431,498) which is within the knowledge of one skilled in the art to facilitate connection of tracks 428 and 430. It is contemplated that return tracks 430 may comprise parallel longitudinal bores drilled axially through depending legs 424 of bearing carriage 412.

End caps 434 are constructed from machine grade aluminum and are formed using known production techniques. End caps 434 may also be made from machine grade material, such as, for example, plastic or steel. Longitudinal mounting bores 436 are formed in each longitudinal end face of bearing carriage 412 and serve to attach end caps 434.

Interior facing surfaces 438 of depending legs 424 are configured and dimensioned to receive track inserts 418. Track inserts 418 are mountable to interior facing surfaces 438. It is envisioned that track inserts 418 may be formed as at least a portion of bearing carraige 412. Inserts 418 are formed of a high quality bearing steel and include a pair of parallel grooves 440. Grooves 440 define inner surfaces 421 of ball tracks 420 which make up a portion of load bearing tracks 428 and return tracks 430 and are configured and dimensioned in an appropriate cross-sectional shape for unguided recirculation of bearing balls 416 within ball tracks 420.

Track inserts 418 can be easily and efficiently formed in long sections by known cold drawing processes and subsequently cut to the desired length prior to assembly. To facilitate manufacture, the cross-sectional area of the track inserts are, preferably, substantially uniform in thickness. It is contemplated that track inserts 418 may, alternatively, be mounted to or formed with rail assembly 414. It is further contemplated that a portion of ball tracks 420 may be formed in rail assembly 414 and/or bearing carriage 412.

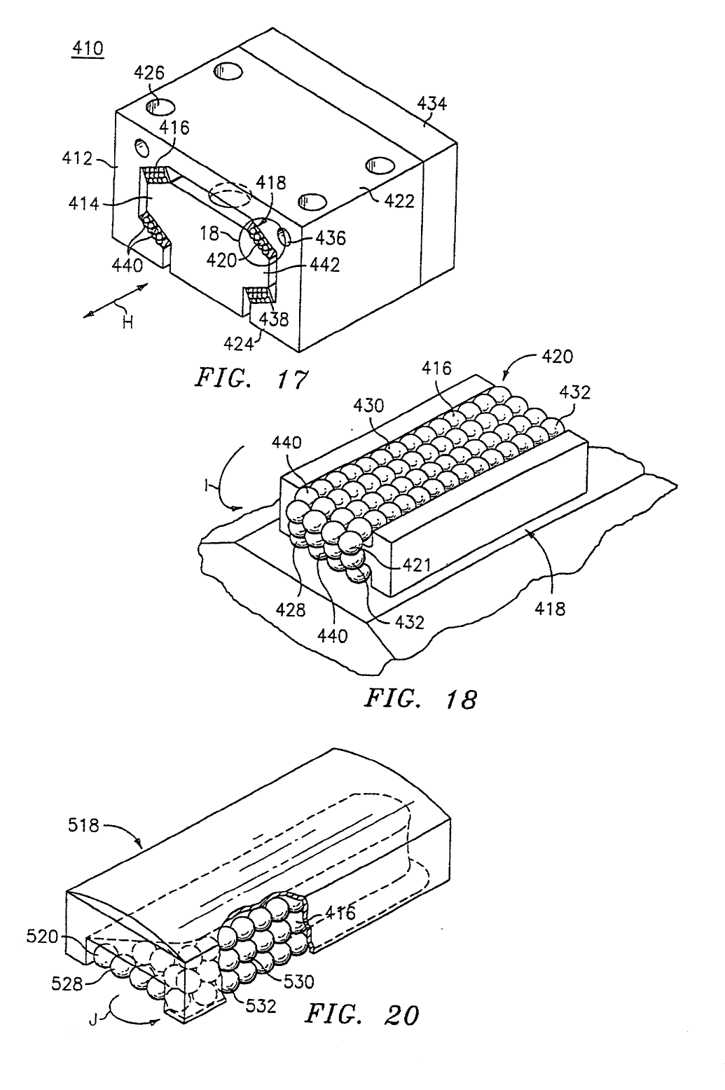

Rail assembly 414 includes an elongate base member 442. Elongate base member 442 is formed of a machine grade aluminum and is extruded using known production techniques. Elongate base member 442 may also be formed of machine grade material, such as, for example, plastic or steel. It is envisioned that base member 442 may have various cross-sectional configurations such as, for example, oval, rectangular, etc. It is contemplated that bearing assembly 410 may include a substantially cylindrical rail assembly 514 and bearing carriage 512, as shown in FIG. 19.

Bearing assembly 410, in accordance with the embodiment shown in FIGS. 16 and 17, is easily and efficiently assembled employing the disclosed components of the present invention. Inserts 418 are positioned on inner surface 438 of bearing carriage 412. Bearing balls 416 are loaded into ball tracks 420 of inserts 418.

Inserts 418 are positioned in mechanical engagement with bearing carriage 412 such that bearing balls 416 are disposed in load bearing tracks 428 and positioned to engage rail assembly 414 to receive an applied load. The remaining components of bearing assembly 410 are appropriately assembled.

Rail assembly 414 moves relative to bearing carriage 412, as shown by arrow H. Elongate member 442 engages bearing balls 416 at load bearing track 428. Bearing balls 416 recirculate within ball track 420, as shown by arrow 1, in an unguided configuration from load bearing track 428, turnarounds 432, to return track 430 and back to load bearing track 428 for engagement with elongate member 442 to advantageously reduce friction, similar to that described above.

It is contemplated that inserts 418 may be positioned on elongate member 442 and in mechanical engagement therewith such that bearing balls 416 are disposed in load bearing track 428 and positioned to engage bearing carriage 412 to receive a load and reduce friction.

Referring to FIG. 20, an alternate embodiment of bearing assembly 410 is shown which includes inserts 518, similar to inserts 418 described with regard to FIGS. 17 and 18. Inserts 518 include a ball track 520 disposed adjacent rail assembly 414 and bearing carriage 412.

Ball track 520 includes a load bearing track 528, a return track 530 and turnarounds 532 interconnecting load bearing track 528 and return track 530. Bearing balls 416 are disposed in ball tracks 520 and ball tracks 520 are configured for unguided recirculation of bearing balls 416, similar to that described with regard to FIGS. 17 and 18.

Return track 530 is laterally oriented to load bearing track 528. Turnarounds 532 includes a funnel configuration for orienting unguided recirculation of bearing balls 416, as shown by arrow J. The funnel configuration of turnarounds 532 advantageously enables improved rigidity of rail assembly 414 and use of larger bearing balls. Inserts 518 also advantageously minimize the profile of inserts 518 to optimize track load and track insert location.

Referring to FIG. 21, another alternate embodiment of bearing assembly 410 is shown which includes track inserts 618, similar to those described above. Inserts 618 include a ball track 620 disposed adjacent rail assembly 414 and bearing carriage 412. Ball track 620 includes a load bearing track 628, a return track 630 and turnarounds 632 interconnecting load bearing track 628 and return track 630.

Bearing balls 416 are disposed in ball tracks 620 and ball tracks 620 are configured for unguided recirculation of bearing balls 416, similar to that described above. Return track 630 includes a divider 631 centrally positioned along the longitudinal length of insert 618 for orienting unguided recirculation of bearing balls 416, as shown by arrow K. Divider 631 advantageously provides increased stiffness to bearing assembly 410.

To the extent not already indicated, it also will be understood by those of ordinary skill in the art that any one of the various specific embodiments herein described and illustrated may be further modified to incorporate features shown in the other specific embodiments.

The invention in its broader aspects therefore is not limited to the specific embodiments herein shown and described but departures may be made therefrom within the scope of the accompanying claims without departing from the principles of the invention and without sacrificing its chief advantages.

What is claimed is:

1. A bearing assembly comprising:
at least one ball track having a load bearing portion, a return portion and a turnaround portion interconnecting said load bearing and return portions; and
a plurality of bearing balls being disposed in said ball tracks;
wherein at least one of either the load bearing or return portions is configured for unguided recirculation of said bearing balls.

2. A bearing assembly according to claim 1, wherein said load bearing portion is configured for unguided recirculation of said bearing balls.

3. A bearing assembly according to claim 1, wherein said return portion is configured for unguided recirculation of said bearing balls.

4. A bearing assembly according to claim 1, wherein said turnaround portion is configured for unguided recirculation of said bearing balls.

5. A bearing assembly according to claim 1, wherein said load bearing, return and turnaround portions are configured for unguided recirculation of bearing balls.

6. A bearing assembly according to claim 1, including a pair of said ball tracks separated by a center rib.

7. A bearing assembly according to claim 1, wherein at least one island is disposed in at least a portion of said ball tracks, said islands facilitating recirculation of said bearing balls in said ball tracks.

8. A bearing assembly according to claim 7, wherein said islands has a substantially parabolic cross-section.

9. A bearing assembly according to claim 1, wherein said load bearing and return portions define substantially parallel axially defined pathways for said bearing balls.

10. A bearing assembly according to claim 1, wherein said return portion includes a divider.

11. A bearing assembly according to claim 1, wherein said return portion is laterally oriented relative to said load bearing portion.

12. A bearing assembly according to claim 1, wherein said ball tracks are substantially elliptical and said load bearing portions are in communication.

13. A bearing assembly comprising:
a block having at least a portion of a pair of ball tracks formed therein, said ball tracks being in communication and including a load bearing portion, a return portion and turnarounds interconnecting said load bearing and return portions; and
a plurality of bearing balls being disposed in said ball tracks;
wherein at least one of either the load bearing or return portions is configured for unguided recirculation of said bearing balls.

14. A bearing assembly comprising:
a rail;
a bearing carriage configured to move along said rail;
at least one ball track disposed adjacent said rail and said bearing carriage, said ball tracks including a load bearing portion, a return portion and a turnaround portion interconnecting said load bearing and return portions; and
a plurality of bearing balls being disposed in said ball tracks; wherein at least one of either the load bearing or return portions is configured for unguided recirculation of said bearing balls.

15. A bearing assembly according to claim 14, wherein said bearing balls are disposed in said load bearing portion and positioned to engage said rail.

16. A bearing assembly according to claim 14, wherein said bearing balls are disposed in said load bearing portion and positioned to engage said carriage.

17. A bearing assembly according to claim 14, wherein at least a portion of said ball tracks are formed in said rail.

18. A bearing assembly according to claim 14, wherein at least a portion of said ball tracks are formed in said bearing carriage.

19. A bearing assembly according to claim 14, further including at least one insert being positional on an inner surface of said bearing carriage, said inserts having at least a portion of said ball tracks formed therein.

20. A bearing assembly according to claim 19, said inserts including parallel grooves defining said load bearing portion and said return portion, said parallel grooves being configured for unguided recirculation of said bearing balls.
